(19) United States
(12) Patent Application Publication
(10) Pub. No.: US 2025/0285187 A1
(43) Pub. Date: Sep. 11, 2025

(54) Heppner Hicks ValueAlt™ - Computer-Implemented Integrated Alternative Asset Valuation System for Factoring the Probability of Loss

(71) Applicants: Brad K. Heppner, Dallas, TX (US); The Beneficient Company Group (USA), L.L.C., Dallas, TX (US)

(72) Inventors: Brad K. Heppner, Dallas, TX (US); Sam Hikspoors, Austin, TX (US); Alican Celik, Frisco, TX (US)

(21) Appl. No.: 18/925,161

(22) Filed: Oct. 24, 2024

Related U.S. Application Data
(63) Continuation of application No. 17/972,091, filed on Oct. 24, 2022, now abandoned.
(60) Provisional application No. 63/324,208, filed on Mar. 28, 2022.

(51) Int. Cl. G06Q 40/06; G06Q 30/0202

(52) U.S. Cl. CPC G06Q 40/06; G06Q 30/0202

(57) ABSTRACT

Disclosed is a computer-implemented system for processing algorithms to calculate a target level of financing of (or investment in) an alternative asset corresponding to a mid-point within a tolerance of a probability of default.

### CROSS-REFERENCE TO RELATED APPLICATIONS

The present application is a continuation of U.S. patent application Ser. No. 17/972,091, filed Oct. 24, 2022, which claims the benefit of and priority to U.S. Provisional Application No. 63/324,208, filed Mar. 28, 2022. The entire contents of each of the foregoing applications are hereby incorporated by reference herein.

### TECHNICAL FIELD

The present disclosure relates to alternative assets, and more particularly, to systems and methods for pricing, underwriting, and/or monitoring Financings relating to Alternative Asset Products.

### BACKGROUND

The efficient valuation of assets is an important part of a stable financial ecosystem. Certain assets have robust markets that provide efficient valuation of such assets. Equity and debt securities, commodity contracts, and derivatives of those instruments, are examples of assets that often have robust public markets that efficiently price such assets. The proper valuation of assets enables individual, corporate, and/or government decision-makers to implement effective financial planning and fiscal management, which contributes to a stable financial ecosystem.

While certain asset classes have efficient valuation provided by robust markets, other asset classes do not. For example, artwork is an example of an asset with inefficient markets and valuation challenges. To improve the stability of financial ecosystems and improve the ability of decision-makers to implement effective financial planning and management, there is demand for improving the ability to provide market participants the value and price of certain asset classes which do not have robust markets and are generally considered to be illiquid.

### SUMMARY

The present disclosure relates to systems and methods of evaluating Alternative Asset Products and/or for pricing, underwriting, and/or monitoring Financings relating to Alternative Asset Products. As used herein, the term “Alternative Asset Products” refers to and includes interest(s), or derivatives thereof, in an alternative asset through a Fund or other alternative asset investment vehicle, as applicable, or a special purpose vehicle holding interest(s) in any of the foregoing. As used herein, the term “Fund” refers to and includes private professionally managed alternative asset investment funds. In various embodiments, the present disclosure relates to a Financing backed by an Alternative Asset Product. As used herein, the term “Financing” shall mean and include any structure or process of providing capital in exchange for a specific agreed-upon return, and/or insurance products providing a specific agreed-upon insurance coverage. For example, a Financing may be in the form of debt or equity instruments or an insurance policy. As used herein, the term “Default” shall mean and include any occurrence or circumstance by which a specific agreed-upon expected return or specific agreed-upon insurance coverage is not satisfied according to the terms of the Financing.

The present disclosure may refer to Alternative Asset Products or interests in Alternative Asset Products when used to back a Financing as a “Reference Asset.” In aspects, the present disclosure provides systems and methods which analyze the potential risks and returns with respect to a Reference Asset in order to evaluate and determine its relevant quality. In aspects, the present disclosure provides systems and methods which set the Financing parameters based on a calculation determining the estimated value of the Reference Asset. In aspects, the present disclosure provides systems and methods for determining a credit rating for a Financing backed by a Reference Asset and for ongoing monitoring of the performance of such Financing. The various aspects can be combined in various ways to price, underwrite, and/or monitor a Financing that relates to Alternative Asset Products.

Various terms above and below may be capitalized to indicate an identification. Unless otherwise indicated, such capitalization is not intended to limit the capitalized term to a particular definition or meaning.

Aspects of the present disclosure may be referred to herein as “ValueAlt.”

In accordance with aspects of the present disclosure, a computer-implemented method includes: projecting future cashflows to and from at least one Alternative Asset Product; determining probabilities of Default of a Financing backed by the at least one Alternative Asset Product, where the probabilities of Default are determined based on a stochastic simulation model which utilizes the projected future cashflows and a target Financing structure; accessing a desired credit rating for the Financing backed by at least one Alternative Asset Product, where the desired credit rating has a corresponding probability of Default; and determining a target Financing level for the Financing based on the stochastic simulation model providing a probability of Default at the target Financing level that is less than a probability of Default applicable to the desired credit rating for the Financing. In other words:

Target Financing Level=x, such that

Probability of Default (x)<Probability of Default applicable to the Desired Credit Rating

In various embodiments of the computer-implemented method, the future cashflows are projected based on fundamental analysis.

In various embodiments of the computer-implemented method, the probabilities of Default of the Financing are determined based on a joint probability distribution for the cashflows of the Alternative Asset Product, where the joint probability distribution is defined by the stochastic simulation model.

In various embodiments of the computer-implemented method, determining the target Financing level for the Financing includes, iteratively: accessing a Financing range for the iteration; bisecting the Financing range into an upper range, a lower range, and a midpoint; comparing a probability of Default at the midpoint provided by the stochastic simulation model with the probability of Default corresponding to the desired credit rating; in a case the probability of Default at the midpoint is within a tolerance of the probability of Default corresponding to the desired credit rating, selecting the midpoint as the target Financing level; and in a case the probability of Default at the midpoint is outside a tolerance of the probability of Default corresponding to the desired credit rating, selecting one of the upper range or the lower range as Financing range for a next iteration.

In various embodiments of the computer-implemented method, determining the target Financing level for the Financing includes, iteratively: accessing a Financing range for the iteration; bisecting the Financing range into an upper range, a lower range, and a midpoint; comparing a credit rating corresponding to a probability of Default at the midpoint provided by the stochastic simulation model with the desired credit rating; in a case the credit rating corresponding to the midpoint is within a tolerance of the desired credit rating, selecting the midpoint as the target Financing level; and in a case the credit rating corresponding to the midpoint is outside a tolerance of the desired credit rating, selecting one of the upper range or the lower range as Financing range for a next iteration.

In various embodiments of the computer-implemented method, the method includes underwriting the Financing based on the target Financing level.

In accordance with aspects of the present disclosure, a system includes one or more processors, and at least one memory storing instructions. The instructions, when executed by the one or more processors, cause the system to: project future cashflows to and from at least one Alternative Asset Product; determine probabilities of Default of a Financing backed by the at least one Alternative Asset Product, where the probabilities of Default are determined based on a stochastic simulation model which utilizes the projected future cashflows and a target Financing structure; access a desired credit rating for the Financing backed by at least one Alternative Asset Product, where the desired credit rating has a corresponding probability of Default; and determine a target Financing level for the Financing based on the stochastic simulation model providing a probability of Default at the target Financing level that is less than a probability of Default applicable to the desired credit rating for the Financing. In other words:

Target Financing Level=x, such that

Probability of Default (x)<Probability of Default applicable to the Desired Credit Rating

In various embodiments of the system, the future cashflows are projected based on fundamental analysis.

In various embodiments of the system, the probabilities of Default of the Financing are determined based on a joint probability distribution for the cashflows of the Alternative Asset Product, where the joint probability distribution is defined by the stochastic simulation model.

In various embodiments of the system, in determining the target Financing level for the Financing, the instructions, when executed by the one or more processors, cause the system to iteratively: access a Financing range for the iteration; bisect the Financing range into an upper range, a lower range, and a midpoint; compare a probability of Default at the midpoint provided by the stochastic simulation model with the probability of Default corresponding to the desired credit rating; in a case the probability of Default at the midpoint is within a tolerance of the probability of Default corresponding to the desired credit rating, select the midpoint as the target Financing level; and in a case the probability of Default at the midpoint is outside a tolerance of the probability of Default corresponding to the desired credit rating, select one of the upper range or the lower range as Financing range for a next iteration.

In various embodiments of the system, in determining the target Financing level for the Financing, the instructions, when executed by the one or more processors, cause the system to iteratively: access a Financing range for the iteration; bisect the Financing range into an upper range, a lower range, and a midpoint; compare a credit rating corresponding to a probability of Default at the midpoint provided by the stochastic simulation model with the desired credit rating; in a case the credit rating corresponding to the midpoint is within a tolerance of the desired credit rating, select the midpoint as the target Financing level; and in a case the credit rating corresponding to the midpoint is outside a tolerance of the desired credit rating, select one of the upper range or the lower range as Financing range for a next iteration.

In various embodiments of the system, the instructions, when executed by the one or more processors, further cause the system to underwrite the Financing based on the target Financing level.

Further details and aspects of exemplary embodiments of the present disclosure are described in more detail below with reference to the appended figures.

### BRIEF DESCRIPTION OF THE DRAWINGS

FIG. 1 is a block diagram of an exemplary transaction between a financier and a recipient, in accordance with aspects of the present disclosure;

FIG. 2 is a block diagram of exemplary operations for evaluating an Alternative Asset Product and/or for pricing, underwriting, and/or rating a Financing backed by interests in an Alternative Asset Product, in accordance with aspects of the present disclosure;

FIG. 3 is a block diagram of an exemplary operation for determining a quality score for an Alternative Asset Product, in accordance with aspects of the present disclosure;

FIG. 4 is a diagram of an exemplary lifecycle of a Fund, in accordance with aspects of the present disclosure;

FIG. 5 is a block diagram of an exemplary operation for determining parameters of a Financing based on the value of an Alternative Asset Product that will back the Financing, in accordance with aspects of the present disclosure;

FIG. 6 is a diagram of an exemplary risk-adjusted return metric as applied to various alternative asset classes, in accordance with aspects of the present disclosure;

FIG. 7 is a block diagram of an exemplary operation for determining a credit rating for a Financing that is backed by interests in an Alternative Asset Product, in accordance with aspects of the present disclosure; and

FIG. 8 is a diagram of an exemplary computing system.

### DETAILED DESCRIPTION

The present disclosure relates to systems and methods for evaluating Alternative Asset Products and/or for pricing, underwriting, and/or monitoring Financings that relate to Alternative Asset Products. Unless otherwise specified or otherwise indicated by the context, the term “alternative asset” is used herein to mean and include any type of asset that does not have a consistently available market by which a holder-of-interests can exchange its interests in the asset for financial remuneration at a time desired by the holder-of-interests. The term “illiquid asset” may be used interchangeably with “alternative asset.” Examples of alternative assets include, without limitation, interests in private equity, venture capital, leveraged buyout, structured credit, private debt, real estate, feeder funds, fund of funds, life insurance policies, natural resources, non-traded business development company, and/or non-traded real-estate investment trusts, and/or other intangible assets, among other things. Unless noted otherwise, the singular and plural forms of “alternative asset” and of “illiquid asset” will be used interchangeably herein, such that any disclosure relating to “alternative asset” is applicable to “alternative assets” as well, and vice versa.

As mentioned above, the term “Alternative Asset Products” refers to and includes interest(s), or derivatives thereof, in an alternative asset through a Fund or other alternative asset investment vehicle, as applicable, or a special purpose vehicle holding interest(s) in any of the foregoing. In various embodiments, the present disclosure relates to a Financing backed by an Alternative Asset Product.

As mentioned above, the term “Fund” refers to and includes private professionally managed alternative asset investment funds.

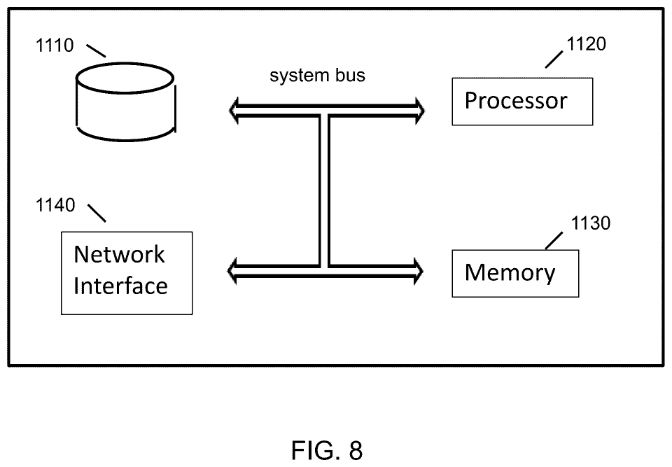

Systems and methods are described below in connection with various figures. The description and figures are intended to be examples of systems and methods according to the present disclosure, and it will be understood that such examples do not limit the scope of the present disclosure. The drawings and description below relate to various operations. Although various operations are presented in a particular sequence, such operations or portions of operations can be implemented in a different sequence than as described or illustrated herein. Additionally, various operations or portions of operations can be implemented concurrently or simultaneously. Portions of one or more operations can be implemented in one or more other operations and/or can be implemented differently than as illustrated or described. The illustrations and descriptions herein may describe operations involving an Alternative Asset Product. It is contemplated that such disclosure can be applied sequentially, concurrently, or simultaneously to more than one Alternative Asset Product. The operations described herein can be implemented by a computing system, which will be described in connection with FIG. 8.

Various terms below may be capitalized to indicate an identification. Unless otherwise indicated, such capitalization is not intended to limit the capitalized term to a particular definition or meaning. In connection with the description below, the following terms have the following meanings.

The term “asset” means and includes anything of value, including any property, whether it is real, personal, fixed, intangible, monetary, or otherwise.

The term “interest” means and includes any legal right in or to an asset.

The term “beneficial interest” means and includes the interests that a beneficiary of a special purpose vehicle (e.g., a trust) has with respect to its interest in such special purpose vehicle.

In the description herein, the terms “asset” and “interest” in an asset may be used interchangeably, such that any description herein relating to an asset shall be applicable any interest in the asset, and any description relating to an interest in an asset shall be applicable to the asset as well. Additionally, description herein relating to an asset or an interest in an asset shall be applicable to an Alternative Asset Product which holds assets or holds interests in assets, and description herein relating to an Alternative Asset Product which holds assets or holds interests in assets shall be applicable to an asset or an interest in an asset.

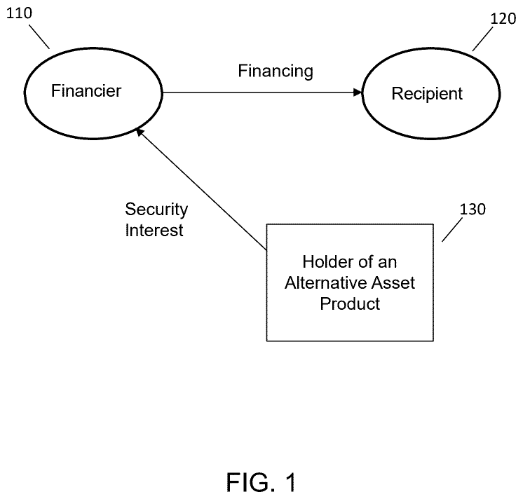

Referring to FIG. 1, there is shown an exemplary transaction between a financier 110 (e.g., a lender) which provides a Financing (e.g., a loan) and a recipient 120 which receives the Financing. Additionally, the exemplary transaction involves a holder 130 of an Alternative Asset Product, which may be the same entity as the recipient 120 or may be a separate entity. For example, in various embodiments, the recipient 120 and the holder 130 may be separate trusts. In various embodiments, the recipient 120 may be a trust and the holder 130 may be a partnership. Other types of entities are contemplated for the recipient 120 and the holder 130. The holder 130 conveys a security interest to the financier 110 such that the Alternative Asset Product serves as a Reference Asset for the Financing.

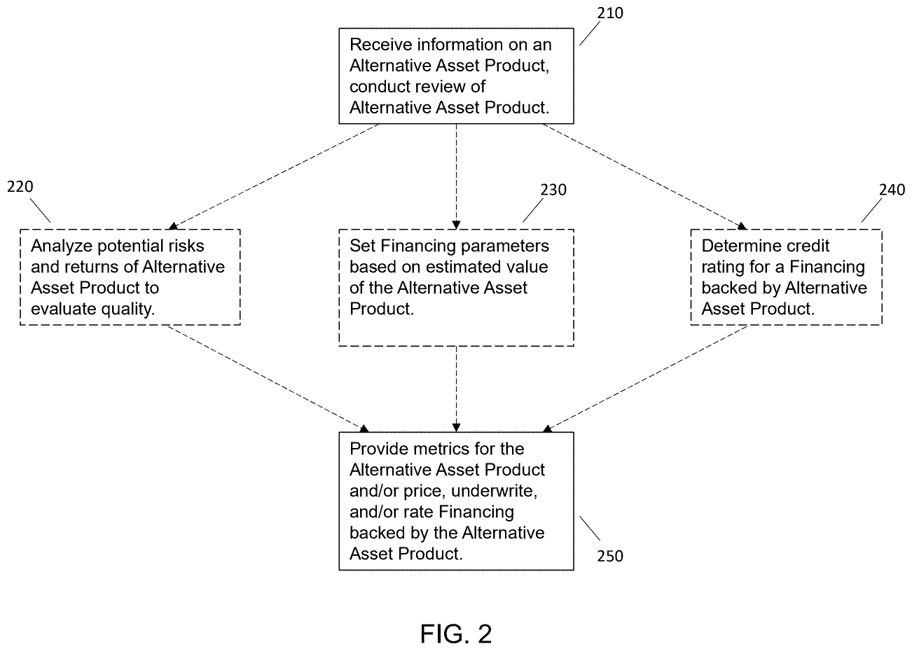

FIG. 2 shows a block diagram of an exemplary operation for evaluating an Alternative Asset Product and/or for pricing, underwriting, and/or rating a Financing backed by interests in an Alternative Asset Product. Some or all of the operations in FIG. 2 may be implemented by a computing system, which will be described later herein in connection with FIG. 8. FIG. 2 includes dashed lines to indicate that the dashed operations may be implemented individually or may be implemented in various combinations.

At block 210, the operation involves receiving information on an Alternative Asset Product that is proposed as a Reference Asset for a new Financing or that is a Reference Asset for an existing Financing. In various embodiments, the information may be received via an online portal, such as a webpage or an app. The information may be submitted by an entity which holds an Alternative Asset Product and which seeks to use such Alternative Asset Product as a Reference Asset for a Financing. Accordingly, the online portal may be a Financing application portal. In various embodiments, the information may be submitted by an entity which would like to obtain a credit rating for an existing Financing that is backed by an Alternative Asset Product. In such embodiments, the online portal may be a credit rating portal. Other embodiments are contemplated to be within the scope of the present disclosure. The received information may include, without limitation, a name of a fund which holds interests in an alternative asset, a name of a general partner or managing firm which manages the fund, an investment/commitment amount, and/or a most recently available net asset value (“NAV”) for the fund. The information described above are exemplary, and other information relating to an Alternative Asset Product may be received, such as, without limitation, a fund's annual audited financials, a fund's quarterly report to investors, and/or most recent schedule K-1 or 1099, among other things. All such other information are contemplated to be within the scope of the present disclosure.

With continuing reference to block 210, the operation involves conducting a review of the Alternative Asset Product based on the received information. The review can evaluate whether the alternative asset underlying an Alternative Asset Product belongs to an approved asset class or type. The terms asset “class” and asset “type” will be used interchangeably herein. In various embodiments, approved classes/types of alternative assets include one or more of the following: private equity, venture capital, leveraged buyout, structured credit, private debt, real estate, feeder funds, fund of funds, life insurance policies, natural resources, non-traded business development company, and/or non-traded real-estate investment trusts. Each approved class of alternative asset can be associated with minimum requirements as well as targeted or preferred characteristics specific to that class of alternative asset. As an example, a minimal requirement may be that the stated net asset value of the specific interest in a fund as reported by the fund manager must be greater than $50,000. As another example, a preferred characteristic may be, for a private equity fund, that at least 25% of committed capital of interest in the fund has been called by the fund manager and contributed by the fund investor. The review can determine whether the minimum requirements for the alternative asset class are satisfied and whether the Alternative Asset Product satisfies targeted or preferred characteristics. If the Alternative Asset Product does not belong to an approved alternative asset class, the review can consider various risk, operational, and financial factors to determine whether the Alternative Asset Product can serve as a Reference Asset for a Financing or whether the Alternative Asset Product can be insured. Such factors can include, without limitation:
Is the asset managed by a professional manager, registered/regulated by a governmental oversight body?
Does the asset have a definitive life by which the asset must be monetized by the manager and proceeds returned to the investor?
Does the asset have characteristics of how it has historical performed and would be expected to performed in the future that suggests that the asset would provide diversification if added as a Reference Asset, or has low or little correlation to the broader investment markets, such as public equities markets?

In various embodiments, the review of block 210 can evaluate whether the Alternative Asset Product has characteristics which make the Alternative Asset Product unsuitable for underwriting, such as, without limitation, unacceptable past performance of the professional manager of the alternative assets (including factors such as adherence and execution to investment and exit strategies and overall portfolio composition) and/or unacceptable non-financial risks, such as intensely negative reputation of the professional manager of the asset, or negative reputation of the asset or asset class. In various embodiments, the review can determine whether the particular Alternative Asset Product has been previously reviewed. The review operations described above are exemplary, and other review operations are contemplated to be within the scope of the present disclosure.

Referring to blocks 220-240, and as mentioned above, the blocks may be implemented individually or in various combinations. Specifically, only one of the three blocks may be implemented, or two of the three blocks may be implemented, or all three blocks may be implemented. Each block is described below.

At block 220, the operation analyzes potential risks and returns of the Alternative Asset Product to evaluate quality of the Alternative Asset Product. In various embodiments, block 220 may be implemented solely to evaluate the quality of an Alternative Asset Product. In various embodiments, block 220 may be implemented to evaluate the quality of an Alternative Asset Product that is proposed as a Reference Asset for a new Financing, or to evaluate the quality of an Alternative Asset Product that is already a Reference Asset for an existing Financing. Other uses are contemplated for applying block 220, and all such uses are contemplated to be within the scope of the present disclosure. In accordance with aspects of the present disclosure, the quality of the Alternative Asset Product can be expressed by a numerical score within a predetermined score range, such as a score between one and one-thousand, or a score within another predetermined range. In various embodiments, the numerical score can indicate a measure of risk and return for the Alternative Asset Product. Various aspects of implementing block 220 will be described in more detail later herein.

At block 230, the operation sets Financing parameters based on estimated value of the Alternative Asset Product. The operation of block 230 determines the value of the Alternative Asset Product and a risk adjusted rate of return specific to the Alternative Asset Product, and uses these metrics to ensure that the Alternative Asset Product would provide sufficient cash flow/returns or “Financing-to-value” to satisfy future promised returns (e.g., distributions, covering required returns, fees, and return of capital), under a range of a Reference Asset performance scenarios. Various aspects of implementing block 230 will be described in more detail later herein.

At block 240, the operation determines a credit rating for a Financing backed by the Alternative Asset Product. In various embodiments, the operation of block 240 estimates the probability of Default and the resulting expected losses that could be sustained on the Financing, based on the Financing level or Financing-to-value at the inception of the proposed Financing or at the inception of an existing Financing. The operation can assign the Financing a credit rating on the OCC (Office of the Comptroller of the Currency) risk grading scale: 1-3 highest and above average, 4-9 satisfactory, 10-13 unsatisfactory, and 14 doubtful and loss. Various aspects of implementing block 240 will be described in more detail later herein.

At block 250, the operation can provide metrics for the Alternative Asset Product and/or can price, underwrite, and/or rate a Financing backed by the Alternative Asset Product. In various embodiments, the operation of block 250 can provide a quality score for the Alternative Asset Product or provide a score indicative of a measure of risk and return for the Alternative Asset Product, which are calculated at block 220. In various embodiments, the operation of block 250 can price and underwrite a Financing backed by interests in the Alternative Asset Product, based on the Financing parameters determined at block 230. In various embodiments, the operation of block 250 can provide a credit rating of a Financing, which is determined at block 240. The credit rating can be a rating of a proposed Financing or can be a rating of an existing Financing. In the case of an existing Financing, the credit rating can be determined from time to time to monitor the Financing over time.

The illustrated embodiment of FIG. 2 is exemplary, and variations are contemplated to be within the scope of the present disclosure. For example, the underwriting of a new Financing backed by an Alternative Asset Product may involve other operations not shown in FIG. 2, and such operations contemplated to be within the scope of the present disclosure. Additional, various aspects of FIG. 2 may be used in underwriting an insurance policy with respect to risks attendant to an Alternative Asset Product.

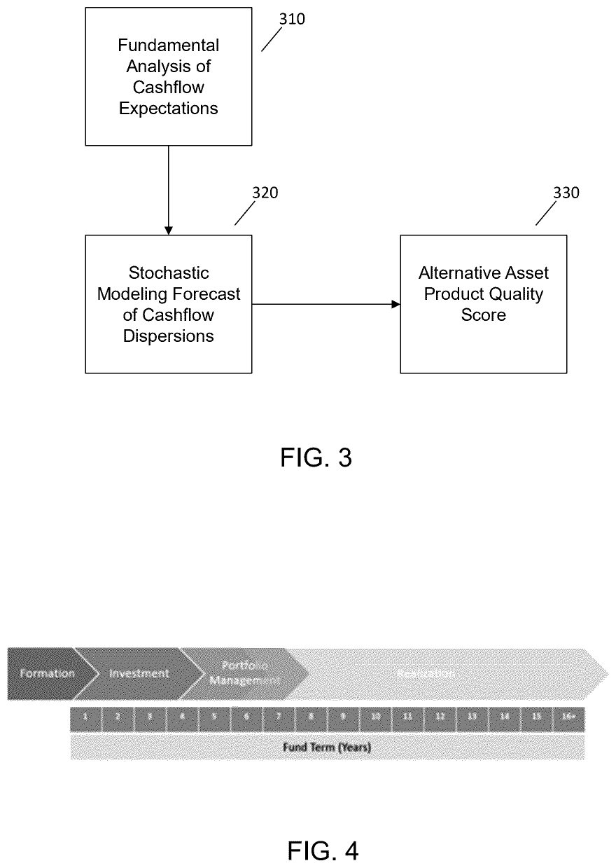

Referring now to FIG. 3, there is shown a block diagram of an exemplary operation for analyzing potential risks and returns of an Alternative Asset Product to evaluate quality of the Alternative Asset Product. As mentioned above in connection with block 220 of FIG. 2, the illustrated operation may be used solely to evaluate the quality of an Alternative Asset Product, or may be used to evaluate the quality of an Alternative Asset Product that is proposed as a Reference Asset for a new Financing, or may be used to evaluate the quality of an Alternative Asset Product that is already a Reference Asset for an existing Financing, among other uses.

As shown in FIG. 3, the operation involves fundamental analysis of cashflow expectations 310, stochastic modeling of cashflow dispersions 320, and computation of an Alternative Asset Product quality score 330. Generally, the operation of FIG. 3 utilizes inputs from fundamental and stochastic risk factors potentially affecting the alternative asset. Each block is explained in more detail below.

At block 310, the operation performs fundamental analysis to provide cashflow expectations for the Alternative Asset Product. The fundamental analysis uses information about the Reference Asset determined by bottom-up analysis, including information which may not otherwise be revealed by analysis of general historical experience of similar assets. In various embodiments, the information can be collected in response to questions that are designed to provide insight on the risk and credit quality of the Alternative Asset Product. In various embodiments, the information can be gathered from sources including initial and secondary data collection, third-party information services (such as analytics providers, market research, databases, periodicals), and other sources such as investment banks, law firms, private equity firms, and/or accounting firms. In various embodiments, the fundamental analysis evaluates “Fund-Specific” risks of the Alternative Asset Product, such as, without limitation, risks that are unique to a specific fund and manager, risk that are focused on the manager, risk that are focused on the underlying investments in the funds, such as the quality of the specific companies or assets invested within the fund. Examples of name-specific risks include one or more of:
Increase in total size from the last fund
Level of institutional limited partnership (LP) retention
General partnership (GP) succession plan
GP ongoing fundraising within fund asset type
GP financial backing
Fund sector focus
Fund geographically focused
Fund GP cash commitment
Fund management fee relative to peers
Fund preferred return relative to peers
Fund carried interest relative to peers
Fund direct alpha relative to peers
Fund KS-PME (Kaplan-Schoar public market equivalent) relative to peers
Prior fund KS-PME relative to peers
Fund distributions concentration
Fund current distributions to paid-in (DPI) multiple relative to peers
Fund dry powder over time
Fund GP current carry
Prior fund quartile
Fund current quartile
Single asset concentration
Does the Fund adhere to its stated/historical investment strategy?
How is the fund manager's ability to source or secure technologies/partners/businesses from outside?
How strong is the fund manager in securing company management talent?
What is the fund manager's reputation/ability as business builder (operational, organic)?
What percent of deals has the fund (or fund manager) co-invested with a top quartile fund?
What is the change in employees at the fund manager since the Private Placement Memorandum (PPM) for the fund?
What has been the partner turnover at the fund manager since the PPM?
What was the average tenure of partners who have left (PPM to current)?
How many funds has the fund manager raised over its history?
How tied is the fund manager's compensation to fund return performance?
What is the fund manager's senior professional turnover over the last 5 years?

The information can be used for fundamental analysis to determine cashflow expectations for the Alternative Asset Product. In various embodiments, the cashflow expectations can be cross-referenced against historical data (e.g., data from databases such as Pregin) to determine how the cashflow expectations based on fundamental analysis compare with historical cashflows for assets with similar types of characteristics, such as assets from similar geography, sector, vintage, and/or sub-asset class. Thus, the operation at block 310 can provide cashflow expectations for the Alternative Asset Product.

At block 320, the operation utilizes stochastic modeling and simulation to forecast cashflow dispersion, where the dispersion of cashflows in different simulation scenarios is calibrated with fundamental and stochastic analysis. The stochastic model is used to identify sources of risk which may impact the same types of assets as those underlying the Alternative Asset Product. The stochastic model identifies the potential dispersion of the cashflows of similar assets in terms of both timing and value on the cashflow realizations. The forecast of the cashflow dispersions may use the cashflow expectations determined by fundamental analysis at block 310. The cashflow dispersions may indicate range of cashflow outcomes of the Alternative Asset Product. In various embodiments, the stochastic model can utilize historical volatilities associated with a Reference Asset (in general) based on characteristics such as the geography, sector, vintage, and/or sub-asset class. In various embodiments, the historical analysis can review uncertainty related to the cashflow timing and the dispersion across time of cashflow realization related to delayed monetization through sales or initial public offerings. Thus, the operation at block 320 can forecast cashflow dispersions for the Alternative Asset Product.

At block 330, the operation provides a quality score for the Alternative Asset Product. As mentioned above, the quality score may be a score in a predetermined score range, such as one to one-thousand, or another predetermined range. The operation at block 330 utilizes the cashflow dispersion forecast, which provides a range of potential cashflows from the Alternative Asset Product. The cashflow dispersion forecast can be used to compute a metric indicative of risk versus return for the Alternative Asset Product, which is denoted herein as “AltUF” and is computed as:

$$AltUF ( Asset ) = μ - ( \frac{1}{2 t} ) λ {σ}^{2} ,$$

where μ is the forecasted internal rate of return (“IRR”), σ² represents variance of IRRs, t is the time horizon (holding period), and λ represents a risk aversion coefficient ranging between −10 (highest level of risk seeking) and +10 (highest level of risk aversion), with 0 being risk neutral. The risk aversion coefficient range is exemplary, and other ranges are contemplated to be within the scope of the present disclosure.

The AltUF risk versus return metric is then converted into a quality score for the Alternative Asset Product. The mapping of the AltUF metric to the quality score can be based on a pre-computed range of AltUF metric values for an Alternative Asset Product. For example, in the case of a private equity fund, the quality score for the Alternative Asset Product can be computed as:

$$AltScore ( Asset ) = 1000 N ( ( {Ω}_{F} - {Ω}_{I} ) / σ ) ,$$

where Ω_{F} and Ω_{I} are the AltUF measure calculated for a private equity fund and of a private equity index representative of the overall private market, respectively, a is a parameter that is chosen to be twice the range of plausible Sharpe ratios for private equity funds, and N is the cumulative Gaussian probability function. Such a mapping in the example above has the effect of increasing the sensitivity of the measure near the center of the scale, at Ω_{F}=Ω_{I}, and decreasing it near the wings Ω_{F}=±∞, where increasing a widens the central sensitized region. The mapping described above is exemplary. Persons skilled in the art will understand how to map the AltUF metric to a quality score for other classes/types of alternative assets and for other predetermined score ranges. Thus, block 330 operates to provide a quality score of an Alternative Asset Product. The quality score can be indicative of a risk versus return metric for the Alternative Asset Product.

As mentioned above, the quality score can be used solely to evaluate the risk versus return of an Alternative Asset Product or can be used to evaluate the quality of an Alternative Asset Product that is proposed as a Reference Asset for a new Financing.

Referring again to the stochastic model and simulation described in connection with block 320, the following provides additional details. In accordance with aspects of the present disclosure, the stochastic model captures the value the Alternative Asset Product over time. The value over time can be captured based on designating various phases of an Alternative Asset Product's lifecycle. As an example, FIG. 4 shows an exemplary lifecycle of a fund which contains interests in alternative assets. As shown in the example of FIG. 4, the lifecycle phases include Investment Period phase, Portfolio Management phase, and Realization phase.

The phases of an Alternative Asset Product's lifecycle can inform the value of the Alternative Asset Product over time. Generally following formation, the first three to five years of a Fund are designated as the Investment Period. The Investment Period is the most active period in a Fund's lifecycle. During this period, the manager/general partner of the Fund is sourcing and evaluating potential investments of the fund, conducting business and valuation due diligence, negotiating term sheets, and closing investment acquisitions. Each such acquisition closed by the manager/general partner generally reduces the Unfunded Capital Commitment of the Fund. In various embodiments, the “Unfunded Capital Commitment” refers to the amount of money an investor in a Fund is obligated to deliver to the manager/general partner of such Fund upon a capital call by the manager/general partner of the Fund. After the Investment Period ends, some of the Unfunded Capital Commitment may still not be called. Additional Unfunded Capital Commitment may continue to be called to fund additional investments and/or for expenses, management fees, and similar expenses. After the Investment Period has expired, Unfunded Capital Commitment calls will generally lessen in frequency and amount. While the manager/general partner has discretion regarding investment decisions for the Fund, the timing and amounts of the holdings in the Fund may be relatively unpredictable due to broader market forces.

In view of the lifecycle dynamics described above, a cashflow projection model can model the interplay between the growing value of the alternative assets of the Fund, the capital calls that add new alternative assets to the Fund, and distribution of those assets from the Fund to investors. The cashflow projection model also models the behavior of the Unfunded Capital Commitment inside and outside the Investment Period. During the Investment Period, distributions from the Fund are assumed to be drawn as a positive fraction of the remaining net asset value (“NAV”) of the Fund in each time step, and the capital calls are taken to be a fraction of the remaining Unfunded Capital Commitment in each time step. Outside of the Investment Period, the Unfunded Capital Commitment is assumed to be written down by a positive rate that is large enough to deplete the remaining Unfunded Capital Commitment almost entirely after one year.

The dynamics NAV of the fund, or NAV of the individual alternative assets, is inferred from dynamics of similar types of assets in the public sector, either by directly regressing the reported NAVs of similar Funds on public factors, or by underwriting analysis, or some other treatment. In addition, the NAV of the Alternative Asset Product decreases at every distribution time by the amount of the distribution. Similarly, the NAV of the Fund increases at every capital call time by the amount of the capital call.

In accordance with aspects of the present disclosure, the cashflow projection model can implement a particular variation referred to herein as “Exponential Distribution Cashflow Model,” which combines statistical data from Fund databases and data derived from underwriting analysis. In the case of a Fund of interests in private companies, the Exponential Distribution Cashflow Model models the private companies owned by the Fund individually, and the NAV, capital calls, distributions, and Unfunded Capital Commitment of each private company are summed to give the total NAV, capital calls, distributions, and Unfunded Capital Commitment for the Fund.

The Exponential Distribution Cashflow Model uses capital call rates inferred statistically from private equity industry databases such as Preqin and uses NAV growth rates and volatilities inferred from models such as CAPM or the Fama-French Models, to infer the statistical properties of the NAV and capital call rates.

The distribution process for each private company owned by the Fund is defined from the expected distribution date derived by an underwriting analysis. The Exponential Distribution Cashflow Model treats this date as the mean of an exponential distribution, so that the Fund distribution process is a sum of exponential random variables. The Exponential Distribution Cashflow Model then adds in extra Boolean state variables to keep track of which assets have already made distributions. Thus, the Exponential Distribution Cashflow Model implements NAV processes for each private company in the Fund, the capital call rates, and the Boolean distribution variable, as random processes within the model.

The Exponential Distribution Cashflow Model is more computationally intensive when a Fund is near its inception. However, for older Funds with fewer private companies left in the Fund, the model is less computationally intensive while being more realistic than typical industry models which treat all company distributions together as a single continuous process. Additionally, the Boolean variables allow the Exponential Distribution Cashflow Model to age properly when a private company is sold earlier or later than expected.

Accordingly, the stochastic models described above permit the process of FIG. 3 to forecast cashflow dispersions and to provide a quality score for an Alternative Asset Product.

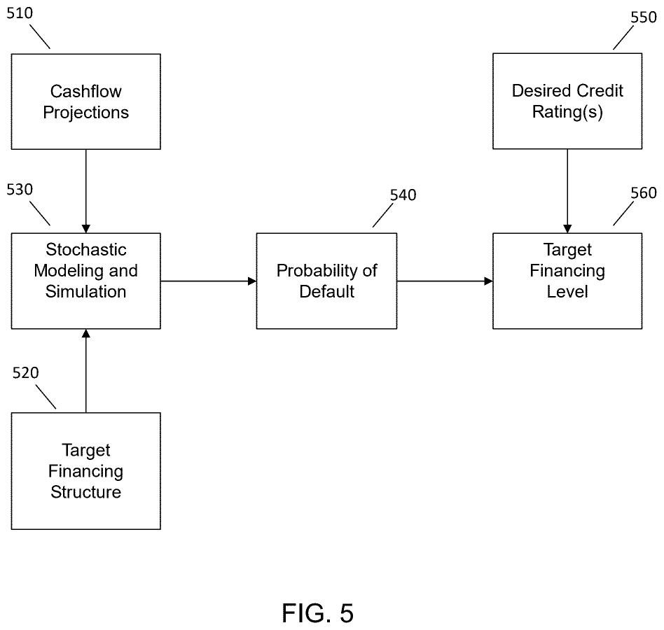

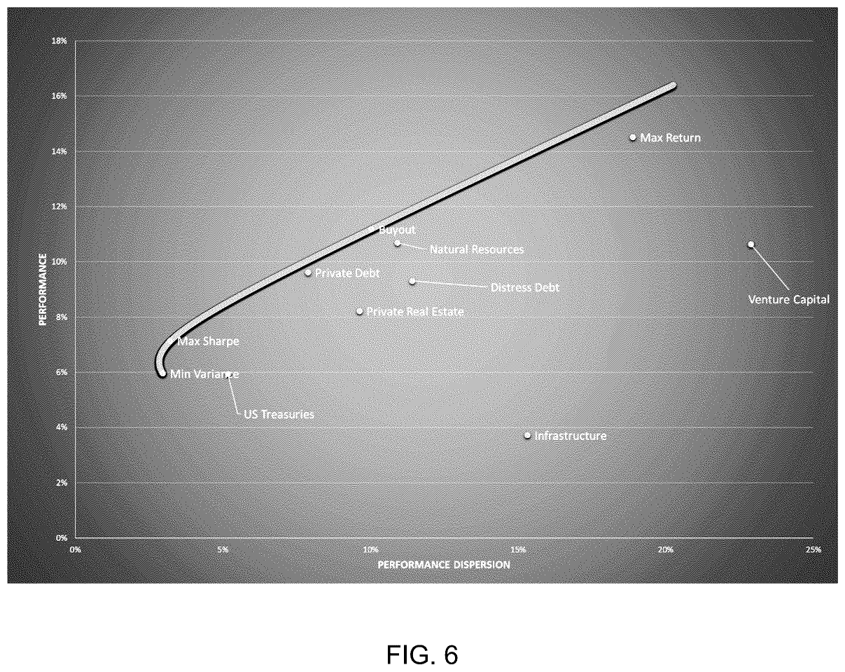

Referring now to FIG. 5, there is shown a block diagram of an exemplary operation for setting Financing parameters based on estimated value of one or more Alternative Asset Products. The operation of FIG. 5 can be implemented at block 230 of FIG. 2. As mentioned above, the operation determines the value of the Alternative Asset Product(s) and a risk adjusted rate of return specific to the Alternative Asset Product(s), and uses one or both of these metrics to ensure that the Alternative Asset Product(s) would provide sufficient cashflow/return or “Financing-to-value” to satisfy future returns (e.g., distributions, covering required returns, fees, and return of capital), under a range of a Reference Asset performance scenarios. In various embodiments, the operation can set certain parameters of a Financing having the Alternative Asset Product(s) as a Reference Asset, in order to meet desired credit ratings. In the case of a Reference Asset of more than one Alternative Asset Product, the Alternative Asset Products may encompass more than one alternative asset class.

Generally, the value of an Alternative Asset Product stems from future cashflows from the Alternative Asset Product or from pools of Alternative Asset Products. At block 510, the operation involves projecting future cashflows to and from an Alternative Asset Product. In various embodiments, the projections can be performed using fundamental analysis, such as the fundamental analysis described above in connection with block 310 of FIG. 3. For example, the fundamental analysis can use information about the Alternative Asset Product determined by bottom-up analysis, including information which may not otherwise be revealed by analysis of general historical experience of similar assets. In various embodiments, the fundamental analysis evaluates “Fund-Specific” risks of the Alternative Asset Product. In various embodiments, the cashflow projections can be cross-referenced against historical data to determine how the cashflow projections based on fundamental analysis compare with historical cashflows for alternative assets with similar types of characteristics, such as alternative assets from similar geography, sector, vintage, and/or sub-asset class. Thus, the operation at block 510 provides cashflow projections for an Alternative Asset Product.

At block 520, the operation accesses a target Financing structure, which can include, among other things, target interest rates and fees. The target Financing structure can allow for cashflows from the Alternative Asset Product backing the Financing to be used to provide the returns on the Financing (e.g., distributions, covering required returns, fees, and return of capital). Other terms can be specified by the target Financing structure, and such terms are contemplated to be within the scope of the present disclosure.

At block 530, the cashflow projections provided at block 510 and the target Financing structure accessed at block 520 can be used by a stochastic model to simulate potential future cashflows. The stochastic model takes into account the target Financing structure features (such as interest rate and fees, among others). In various embodiments, the stochastic model can take into account the structure of the Alternative Asset Product. In various embodiments, the stochastic model can take into account risk factors affecting the return profile of an Alternative Asset Product. In various embodiments, the stochastic model can compute the volatility of each Alternative Asset Product using forward looking risk models which leverage the volatilities and covariance information associated with a Reference Asset and key market factors, based on Alternative Asset Product characteristics such as the geography, sector, vintage, and/or sub-asset class. The stochastic model can also account for uncertainty related to cashflow timing and the dispersion across time of private cashflow realization, related to delayed monetization through sales or IPOs. Thus, block 530 provides a range of potential future cashflows from the Alternative Asset Product.

In accordance with aspects of the present disclosure, the combination of Alternative Asset Product cashflows and target Financing structure inside the stochastic simulation at block 530 results in a model which is stochastic in nature and which defines a joint probability distribution for the cashflows of the Alternative Asset Product at each time. From this joint probability distribution, probabilities of Default of a Financing backed by the Alternative Asset Product may be computed at block 540. In various embodiments, the operation at block 540 can take into account the mechanics of any cashflow waterfall. As mentioned above, the probability of Default refers to and includes the probability any occurrence or circumstance by which the specific agreed-upon expected return or specific agreed-upon insurance coverage is not satisfied according to the terms of the Financing.

At block 550, the operation accesses one or more desired credit ratings for a Financing. As mentioned above, a Financing may have a credit rating on the OCC (Office of the Comptroller of the Currency) risk grading scale: 1-3 highest and above average, 4-9 satisfactory, 10-13 unsatisfactory, and 14 doubtful and loss. The operation may underwrite multiple Financing having different credit ratings. For example, the operation may underwrite certain Financing with a credit rating of A and may underwrite other Financing with a credit rating of B. The desired credit ratings may be based on a Credit Risk Loan Policy, among other things. Thus, one or more desired credit ratings is accessed at block 550.

At block 560, the operation involves determining a target Financing level based on a probability of Default determined at block 540 and the desired credit rating(s) accessed at block 550. As used herein, the target Financing level (or Financing-to-Value at the inception of a Financing) is the initial Financing balance which, when backed by the prospective Alternative Asset Product, implies a probability of Default that is equal to a certain pre-specified percentage, such as equal to the probability of Default corresponding to a desired credit rating.

The operation at block 560 can determine the target Financing level by an iterative process. First, an initial bracket of Financing amounts is set to encompass the target Financing level. The upper bound of the initial bracket is a finite Financing amount which implies a probability of Default (determined at block 540) that is greater than the probability of Default corresponding to the desired credit rating. The lower bound of the initial bracket is zero Financing amount. Thus, the initial bracket will contain the target Financing level somewhere in its range. In various embodiments, the probability of Default implied by the upper bound and the lower bound can be mapped to credit ratings, which would be above and below the desired credit rating.

Once the initial bracket is determined, initial bracket can be bisected and the midpoint of the bracket (i.e., the average of the upper and lower bound) can be evaluated to determine the implied probability of Default at the midpoint and/or the credit rating corresponding to the midpoint. If the implied probability of Default at the midpoint is higher than the probability of Default corresponding to the desired credit rating, or the credit rating at the midpoint is lower than the desired credit rating, then the midpoint becomes the new upper bound of the bracket. If the implied probability of Default at the midpoint is lower than the probability of Default corresponding to the desired credit rating, or the credit rating at the midpoint is higher than the desired credit rating, then the midpoint becomes the new lower bound of the bracket.

The bisection process then iterates until the implied probability of Default at the midpoint is exactly equal to or within a tolerance of the probability of Default corresponding to the desired credit rating, or the credit rating corresponding to midpoint is equal to or within a tolerance of the desired credit rating. At that point, the Financing amount value of the midpoint is used as the target Financing level. Because the probability of Default is a continuous and monotonic function of the Financing amount, the bisection process will arrive at the target Financing level, with the size of the bracket at each iteration being halved for the subsequent iteration. Thus, the operation of block 560 can be used to determine a target Financing amount for a Financing backed by an Alternative Asset Product, to achieve a desired credit rating.

The operations shown in FIG. 5 are exemplary, and variations are contemplated to be within the scope of the present disclosure. For example, in various embodiments, the operations of block 535 may not be performed. In various embodiments, the process of determining a target Financing level may be different from the process described in connection with block 560. Such and other variations are contemplated to be within the scope of the present disclosure.

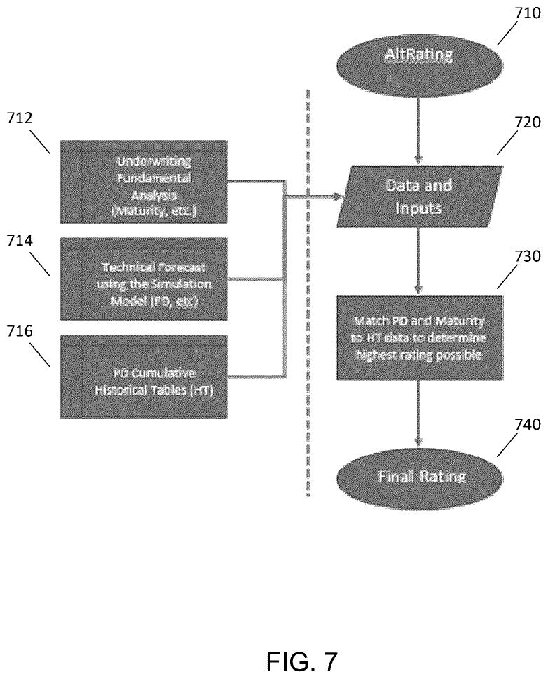

Referring now to FIG. 7, there is shown a block diagram of an exemplary operation for determining a credit rating for a Financing backed by one or more Alternative Asset Products. The operation of FIG. 7 can be implemented by block 240 of FIG. 2, for example. The operation of FIG. 7 is tailored and especially suitable for Financing backed by one or more Alternative Asset Products. The credit ratings assigned by the operation of FIG. 7 have the following characteristics. The credit ratings are consistent with the rating system used by regulatory agencies, and each level is defined as follows:

| | |
|---|---|
| A = Highest | A well-structured Financing with an adequate level |
| and Above | of Reference Asset; such as asset backed Financing |
| Average. | may be rated investment grade by an investment |
| | rating agency or should meet similar quality |
| | standards; or a very strong and well-structured |
| | credit; while the Financing may not be as seasoned |
| | or as high quality, it has sufficient credit strength |
| | so as not to represent a concern to management. |
| B = | Financing relationships that require more than the |
| Satisfactory. | usual amount of management attention. Adverse |
| | industry conditions, deteriorating financial |
| | conditions, declining trends, management |
| | problems, or other similar weaknesses may be |
| | evident. Ability to meet current payment |
| | schedules is deteriorating, even though returns |
| | (e.g., interest and principal) are still being paid |
| | as agreed. Financing may be especially mentioned |
| | (OLEM) by examiners. Financing with a B rating |
| | are considered watch credits and will be listed for |
| | management's attention. |
| C = | Financing possessing weaknesses that jeopardize |
| Unacceptable. | the ultimate collection of total outstanding returns. |
| | The weaknesses require close supervision by |
| | management. Loss may not be evident; however, |
| | the Financing is inadequately protected by current |
| | financials or pledged Reference Asset. The |
| | Financing may be classified as substandard. |
| D = Doubtful | Financing or portions of Financing with one or |
| and Loss. | more weaknesses, which, on the basis of |
| | currently existing facts, conditions, and values, |
| | make ultimate collection of all returns (e.g., |
| | principal) highly questionable, or Financing that |
| | are not bookable assets. For Financing where the |
| | possibility of loss is high, and specific Financing |
| | loss reserve allocations should be made. However, |
| | the amount of certainty of eventual loss may |
| | not be known because of specific pending |
| | factors. Pending factors include: |
| | Litigation |
| | Proposed merger or acquisition, or liquidation in |
| | progress |
| | Injection of new capital in progress or re- |
| | Financing plans in progress |
| | Borrower is in process of providing additional |
| | support such as Reference Asset. |

Pending factors must be supportable and have occurred within a reasonable period of time. They should be disregarded if they extend longer than 9 months.

Referring now to block 720, the operation accesses data and inputs. The data and inputs can include a quality score 710 (which may be referred to as “AltRating”) for the Alternative Asset Product(s) backing the Financing, metrics determined by fundamental analysis 712, metrics determined by technical analysis using stochastic modeling and simulation 714, and a historical cumulative Default probability table 716. In various embodiments, the quality score 710 for the Alternative Asset Product(s) backing the Financing can be the quality score described in connection with block 330 of FIG. 3. The metrics determined by fundamental analysis 712 can include, for example, Financing maturity, among other things. The metrics determined by technical analysis using stochastic modeling and simulation 714 can include, for example, probability of Default of the Financing, among other things. In various embodiments, the probability of Default can be the probability of Default described in connection with block 540 of FIG. 5. Further details of the probability of Default are described below. The historical cumulative Default probability table 716 is also described below.

With respect to the probability of Default metric 714, and as mentioned above, the metric can be computed using the operation described in connection with block 540 of FIG. 5. The operation of block 540 uses the results of the stochastic modeling and simulation of block 530. In particular, for each Financing denoted as Financing Li, the stochastic modeling and simulation can perform a number N_{Li} of simulation paths. In some of those simulations, the returns on the Financing Li are fully paid as promised. In some of the simulations, however, the returns on the Financing Li are not fully paid and are considered to have Defaulted. The percentage of Financing Defaults in the simulations for Financing Li is then:

PD_{Li}=Number of Default Events in Stochastic Simulation of Li/N_{Li},

where N_{Li} is the total number of simulation paths. In accordance with aspects of the present disclosure, the percentage of Defaults PD_{Li} can be used as an estimate for the probability of Default. In particular, for a sufficiently large number of simulations N_{Li}, the percentage of Defaults PD_{Li} can approach the true probability of Default.

With respect to the historical cumulative Default probability table 716, the tables 716 can be created using discrete-time approximation of the non-parametric continuous time hazard rate methodology or life table method, which persons skilled in the art will recognize. According to such methodology, cohorts of issuers are formed using ratings held on a given date. Default and survival of the members of each cohort are tracked over a period of time, and cumulative results are summarized in tables where each row represents a rating and each column represents a time period from formation of a cohort. An example is a historical cumulative Default probability table provided by Moody's Investors Service, but such a table may be created as described above or may be provided by other companies or services. Using such a table, the column corresponding to the desired time period (e.g., maturity of a loan) can be located to determine the historical cumulative Default probabilities for various ratings. An exemplary historic cumulative Default probability table is shown below for an arbitrary maturity of a loan.

| Internal | | OCC Risk | Probability of Default for |
|---|---|---|---|
| Rating | Brief Description | Grading | Simulation Model Maturity |
| A | Highest and Above | 1-3 | 0.2 |
| | Average | | |
| B | Satisfactory | 4-9 | 3.0 |
| C | Unacceptable | 10-13 | 20.0 |
| D | Doubtful and Loss | 14 | n.a. |

At block 730, the operation maps the probability of Default metric 714 to the historical cumulative Default probability tables 716 to determine the highest quality rating for the particular maturity such that the probability of Default 714 is less than the value for the rating in the probability of Default historical table 716 for the maturity. Based on the matching, block 740 assigns the corresponding credit rating to the Financing. Accordingly, the operation of FIG. 7 provides a credit rating for a Financing that is backed by one or more Alternative Asset Products or for a new Financing that is proposed to be backed an Alternative Asset Product. In various embodiments, the credit rating provided by FIG. 7 can be determined for an existing Financing from time to time to monitor the credit rating of an existing Financing over time.

Accordingly, described above are various operations for evaluating alternative assets and/or for pricing, underwriting, rating, and/or monitoring Financing backed by Alternative Asset Products or interests in Alternative Asset Products. As mentioned above, the operations can be implemented by a computer system. FIG. 8 is a block diagram of an exemplary system for implementing the disclosed operations, in accordance with aspects of the present disclosure.

The system of FIG. 8 includes a database 1110, one or more processors 1120, at least one memory 1130, and a network interface 1140. In various embodiments, the computing system can be a proprietary server or can be a hosted server in the cloud. In embodiments, the computing system can be a single server or can include multiple servers in a single location or distribution across different locations.

The storage 1110 includes any device or material from which information may be accessed or reproduced, or held in an electromagnetic, optical, or other form for access by a computer processor. An electronic storage may be, for example, volatile memory such as RAM, non-volatile memory which permanently holds digital data until purposely erased (such as flash memory or solid state drives), magnetic devices such as hard disk drives, and/or optical media such as a CD, DVD, Blu-ray disc, among other storages.

In aspects of the present disclosure, the storage 1110 can store identity of an investor, trust documents for the various trusts, account information for the Financing, account information for the various trusts, and/or financial account information for deposit and transfer funds between the various entities, among other things. The data can be stored in the storage 1010 and sent via the system bus to the processor 1120. The system bus can be localized or network-based, and the storage need not co-reside with the processor and server memory, as long as all components are in communication with each other.

The processor 1120 executes instructions that can be stored in the memory 1130 and utilizes the data from the storage 1110. The instructions can execute the operations disclosed above herein. The computing system can communicate with other devices and servers through the network interface 1140. For example, the computing system can communicate with a third-party server that stores account information.

In various embodiments, the computing system of FIG. 8 can include software applications that implement the transactions and operations described above herein. For example, various transactions may be transactions or portions of transactions can be implemented in a different sequence than as described or illustrated herein. Additionally, various transactions or portions of transaction can be implemented concurrently or simultaneously. Portions of one or more transactions can be implemented in one or more other transaction. In accordance with aspects of the present disclosure, a software application can be used to specify such different arrangements and timing of transactions or portions of transactions such that different investors can have different timing or different implementation of transactions. The software application can be used to arrange and rearrange the transactions with ease using, for example, a graphical user interface (not shown). Account information stored in the storage 1110 and the network interface 1140 can allow the pre-arranged transactions to be communicated with various entities and institutions.

In various embodiments, one or more software applications can implement an investor/client and advisor-credentialed site for the initiation of liquidity requests. Investors can provide details about alternative assets, upload asset documents, and track the progress of a transaction. They can also download a binding term sheet, when available, and request verification of accreditation.

In various embodiments, one or more software applications can implement an underwriting and risk application for documenting valuation, pricing, and ultimate offering terms. The application can incorporate a controlled sequence of tasks to ensure all parties complete their assigned responsibilities. The application can include manager approvals throughout the transaction and can provide the ability to manage multiple portfolios and offering scenarios within a single transaction, as well as selection of final deal terms to feed into other applications or systems.

In various embodiments, one or more software applications can implement an account and transaction management application, which can be used by originations, legal, and investment operations teams. The originations team can use the application to create new accounts for investors and advisors. The legal team can use the application to review investor-provided information for purposes of anti-money laundering or other efforts. The legal team can also use the application to provide deal terms required for the generation of trust and other documents. The investment operations team can use the application to compile and distribute transaction documents, including the binding term sheet and various plan documentation.

In various embodiments, one or more software applications can implement automated generation of trust documents using data provided by one or more other application described above, can implement distribution of trust documents to appropriate parties, and can implement creation and review of accounting journal entries. Various other functionalities can be implemented.

The embodiment of FIG. 8 is exemplary, and variations are contemplated to be within the scope of the present disclosure.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The systems described herein may also utilize one or more controllers to receive various information and transform the received information to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform one or more methods and/or algorithms.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A computer-implemented method comprising:
projecting future cashflows to and from at least one Alternative Asset Product;
determining probabilities of Default of a Financing backed by the at least one Alternative Asset Product, the probabilities of Default determined based on a stochastic simulation model which utilizes the projected future cashflows and a target Financing structure;
accessing a desired credit rating for the Financing backed by the at least one Alternative Asset Product, the desired credit rating having a corresponding probability of Default; and
determining a target Financing level for the Financing based on the stochastic simulation model providing a probability of Default at the target Financing level that is less than a probability of Default applicable to the desired credit rating for the Financing.

2. The computer-implemented method of claim 1, wherein the future cashflows are projected based on fundamental analysis.

3. The computer-implemented method of claim 1, wherein the probabilities of Default of the Financing are determined based on a joint probability distribution for the cashflows of the Alternative Asset Product, the joint probability distribution defined by the stochastic simulation model.

4. The computer-implemented method of claim 1, wherein determining the target Financing level for the Finance includes, iteratively:
accessing a Financing range for the iteration;
bisecting the Financing range into an upper range, a lower range, and a midpoint;
comparing a probability of Default at the midpoint provided by the stochastic simulation model with the probability of Default corresponding to the desired credit rating;
in a case the probability of Default at the midpoint is within a tolerance of the probability of Default corresponding to the desired credit rating, selecting the midpoint as the target Financing level; and
in a case the probability of Default at the midpoint is outside the tolerance of the probability of Default corresponding to the desired credit rating, selecting one of the upper range or the lower range as Financing range for a next iteration.

5. The computer-implemented method of claim 1, further comprising underwriting the Financing based on the target Financing level.

6. A system comprising:
one or more processors; and
at least one memory storing instructions which, when executed by the one or more processors, cause the system to:
project future cashflows to and from at least one Alternative Asset Product;
determine probabilities of Default of a Financing backed by the at least one Alternative Asset Product, the probabilities of Default determined based on a stochastic simulation model which utilizes the projected future cashflows and a target Financing structure;
access a desired credit rating for the Financing backed by the at least one Alternative Asset Product, the desired credit rating having a corresponding probability of Default; and
determine a target Financing level for the loan based on the stochastic simulation model providing a probability of Default at the target Financing level that is less than a probability of Default applicable to the desired credit rating for the Financing.

7. The system of claim 6, wherein the future cashflows are projected based on fundamental analysis.

8. The system of claim 6, wherein the probabilities of Default of the Financing are determined based on a joint probability distribution for the cashflows of the Alternative Asset Product, the joint probability distribution defined by the stochastic simulation model.

9. The system of claim 6, wherein in determining the target Financing level for the Financing, the instructions, when executed by the one or more processors, cause the system to iteratively:
access a Financing range for the iteration;
bisect the Financing range into an upper range, a lower range, and a midpoint;
compare a probability of Default at the midpoint provided by the stochastic simulation model with the probability of Default corresponding to the desired credit rating;
in a case the probability of Default at the midpoint is within a tolerance of the probability of Default corresponding to the desired credit rating, select the midpoint as the target Financing level; and
in a case the probability of Default at the midpoint is outside the tolerance of the probability of Default corresponding to the desired credit rating, select one of the upper range or the lower range as Financing range for a next iteration.

10. The system of claim 6, wherein the instructions, when executed by the one or more processors, further cause the system to underwrite the Financing based on the target Financing level.
